(19) United States
(12) Patent Application Publication
(10) Pub. No.: US 2010/0291873 A1
(43) Pub. Date: Nov. 18, 2010

(54) COMMUNICATION TERMINAL DEVICE AND TRIPARTITE COMMUNICATION METHOD

(75) Inventors: Hiroyuki Nakai, Kawasaki (JP); Katsuaki Akama, Kawasaki (JP); Shoichi Sato, Kawasaki (JP); Hiroshi Fushikida, Kawasaki (JP); Tetsuya Murata, Kawasaki (JP); Hiroshi Kawasaki, Kawasaki (JP); Hiromi Watanabe, Kawasaki (JP); Hiroshi Karasawa, Kawasaki (JP); Tetsuya Matsuda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/766,190

(22) Filed: Apr. 23, 2010

(30) Foreign Application Priority Data
May 18, 2009 (JP) 2009-120318

(51) Int. Cl. H04B 7/00

(52) U.S. Cl. 455/41.2

(57) ABSTRACT

A communication terminal device includes a terminal body which enables a communication with a radio communication network by a first radio communication, a separating member which may be separated from the terminal body and enables a communication with the terminal body by a second radio communication, a tripartite communication unit which enables a tripartite communication among the terminal body, the separating member, and the radio communication network when the separating member and the terminal body are separated, and a control unit which controls howling between the terminal body and the separating member when the separating member and the terminal body are close during the tripartite communication.

### CROSS-REFERENCE TO RELATED APPLICATIONS

This application is based upon and claims the benefit of priority from the prior Japanese Patent Application No. 2009-120318 filed on May 18, 2009, the entire contents of which are incorporated herein by reference.

### FIELD

Various embodiments described herein relate to a communication terminal device such as, for example, a mobile phone in which a prescribed separating member is able to be separated from a terminal body and to a communication method.

### BACKGROUND

A typical method for realizing a tripartite communication by a communication terminal device having a master unit, includes call control with respect to a radio communication network, and a slave unit, which realizes a communication with the radio communication network via the master unit. In this typical technique, for example, if a tripartite communication request is detected during a voice communication between the master unit and the radio communication network, a tripartite communication among the master unit, the slave unit, and a partner of the radio communication network is established. The typical technique is discussed in, for example, Japanese Laid-open patent publication No. 2004-179981 and Japanese Laid-open patent publication No. 11-275663.

The communication terminal device that realizes the above-described tripartite communication method enables a tripartite communication among the master unit, the slave unit, and the partner of the radio communication network. However, for example, if it is assumed that a mobile phone is able to be separated into the master unit and the slave unit, when the master unit is close to or is combined with the slave unit during the tripartite communication among the master unit, the slave unit, and the partner of the radio communication network, howling may be caused between the communication unit of the master unit and the communication unit of the slave unit.

### SUMMARY

According to an aspect of the invention, a communication terminal device includes a terminal body which enables a communication with a radio communication network by a first radio communication, a separating member which may be separated from the terminal body and enables a communication with the terminal body by a second radio communication, a tripartite communication unit which enables a tripartite communication among the terminal body, the separating member, and the radio communication network when the separating member and the terminal body are separated, and a control unit which controls howling between the terminal body and the separating member when the separating member and the terminal body are close during the tripartite communication.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is an explanation diagram illustrating outline configurations of a mobile phone in a combination state and a separation state according to an embodiment,

FIG. 2 is a block diagram illustrating an outline configuration inside a mobile phone,

FIG. 3 is a block diagram illustrating an outline configuration inside a first control unit as a main part of a phone body,

FIG. 4 is a block diagram illustrating an outline configuration inside a second control unit as a main part of a separating member,

FIG. 5 is an explanation diagram illustrating an outline configuration inside a distribution composition unit of a phone body,

FIG. 6 is an explanation diagram illustrating an outline configuration inside a voice switching unit of a separating member,

FIG. 7A is an operation sequence illustrating processing operation(s) of a phone body, a separating member, and a radio communication network related to communication voice switching processing,

FIG. 7B is another operation sequence illustrating processing operation(s) of a phone body, a separating member, and a radio communication network related to a communication voice switching processing,

FIG. 7C is another operation sequence illustrating processing operation(s) of a phone body, a separating member, and a radio communication network related to a communication voice switching processing,

FIG. 8 is an explanation diagram clearly illustrating internal operation(s) of a phone body and a separating member related to a time of an incoming call in a compact storage standby state,

FIG. 9 is an explanation diagram clearly illustrating internal operation(s) of a phone body and a separating member related to a time of an incoming call in a normal communication standby state,

FIG. 10 is an explanation diagram clearly illustrating internal operation(s) of a phone body and a separating member related to a time of an incoming call in a separation state,

FIG. 11 is an operation sequence illustrating processing operation(s) of a phone body, a separating member, and a radio communication network when a normal communication is shifted to a tripartite communication,

FIG. 12 is an explanation diagram clearly illustrating internal operation(s) of a phone body and a separating member when a normal communication is shifted to a tripartite communication,

FIG. 13 is another operation sequence illustrating processing operations of a phone body, a separating member, and a radio communication network when a normal communication is shifted to a tripartite communication, and

FIG. 14 is another explanation diagram clearly illustrating internal operation(s) of a phone body and a separating member when a normal communication is shifted to a tripartite communication.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

With reference to the diagrams, detailed description will be made below of an embodiment of a communication terminal device and a tripartite communication method that are disclosed in the present invention.

An outline of an embodiment will describe a mobile phone that includes a phone body, which enables a communication via a radio communication network, and a separating member, which may be separated from the phone body and enables a radio communication such as a Bluetooth (hereinafter referred to as BT) communication with the phone body.

Furthermore, when the separating member is separated from the phone body, the mobile phone includes a tripartite communication unit, which enables a tripartite communication among the phone body, the separating member, and the radio communication network, and a control unit, which prevents and controls howling caused between the phone body and the separating member when the separating member is close to the phone body, for example, when the separating member is combined with the phone body during the tripartite communication.

As a result, according to an embodiment, during the tripartite communication using the phone body and the separating member that is able to be separated from the phone body, the howling may be prevented even when the separating member is close to the phone body, for example, even when the separating member is combined with the phone body.

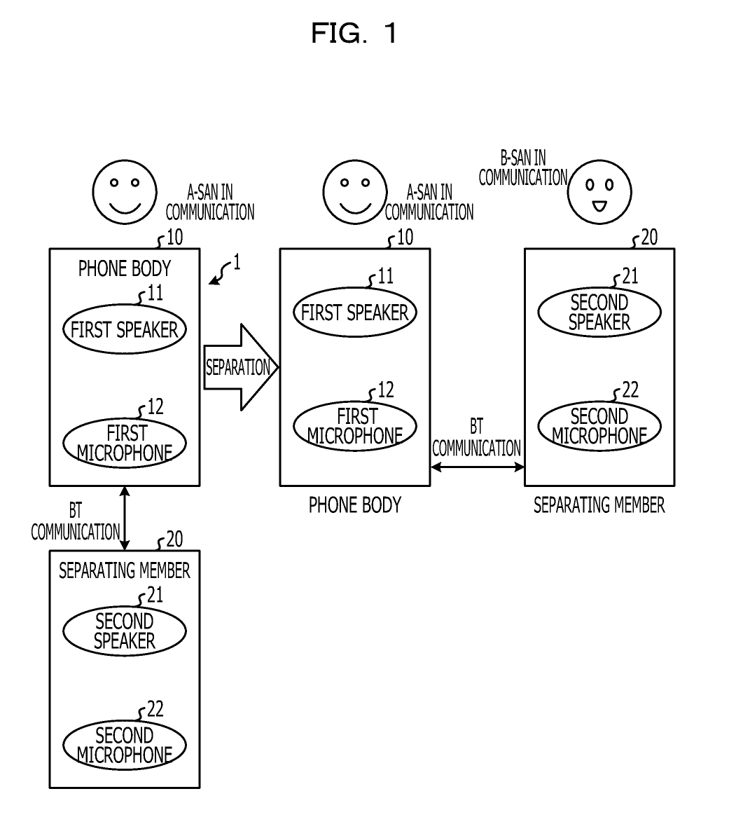

FIG. 1 is an explanation diagram illustrating outline configurations of the mobile phone in the combination state and the separation state according to an embodiment,

A mobile phone 1 illustrated in FIG. 1 includes a phone body 10, which enables a communicable with a partner via a radio communication network, and a separating member 20, which is able to be separated from the phone body 10 and may communicate with the phone body 10 with a BT communication.

When the phone body 10 is combined with and connected to the separating member 20, an upper part of the separating member 20 is rotatable in relation to a lower part of the phone body 10, so that the separating member 20 may be detachably separated from the lower part of the phone body 10.

The phone body 10 includes a first speaker 11, which outputs a received voice, in an upper part thereof, and a first microphone 12, which collects a transmitted voice, in a lower part thereof. The separating member 20 includes a second speaker 21, which outputs reception voice on, an upper part thereof, and a second microphone 22, which collects transmission voice, on a lower part thereof.

The mobile phone 1 has at least two types of combination state of the phone body 10 and the separating member 20 including a compact standby state in which the surface of the phone body 10 is overlapped with the surface of the separating member 20, and a normal communication standby state in which the surface of the phone body 10 and the surface of the separating member 20 are open.

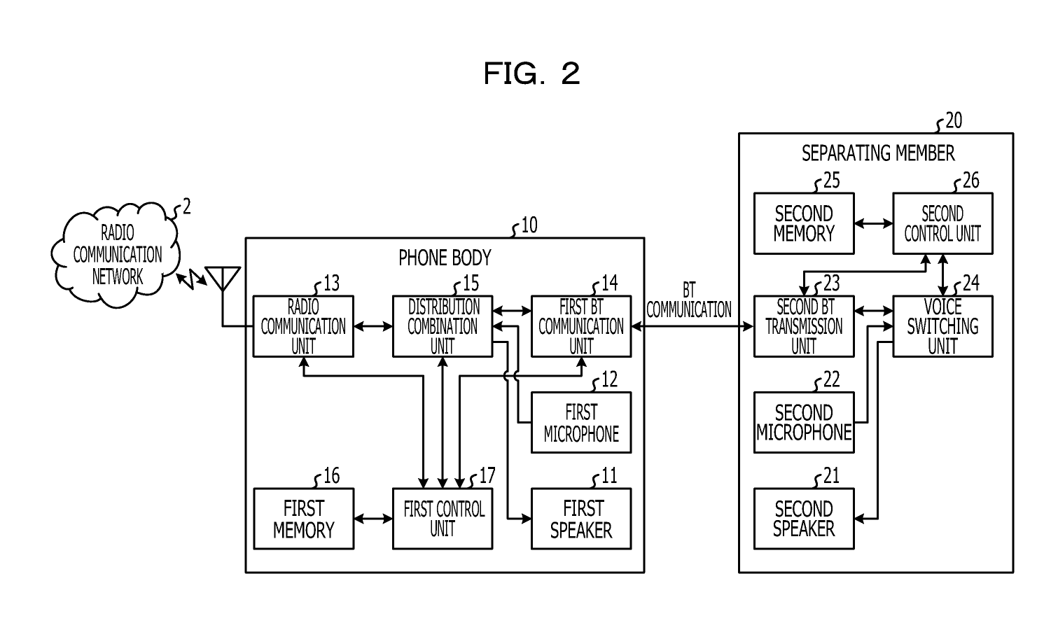

FIG. 2 is a block diagram illustrating an outline configuration inside the mobile phone 1.

In addition to the first speaker 11 and the first microphone 12, the phone body 10 in the mobile phone 1 illustrated in FIG. 2 may include a radio communication unit 13 that controls a communication interface with respect to a base station in the radio communication network 2, a first BT communication unit 14 that controls the communication interface of the BT communication, a distribution combination unit 15 that distributes or composes communication voices, a first memory 16 that stores various information, and a first control unit 17 that controls the whole phone body 10.

In addition to the second speaker 21 and the second microphone 22, the separating member 20 in the mobile phone 1 may include a second BT communication unit 23 that controls a communication interface of the BT communication on the phone body 10 side, a voice switching unit 24 that switches the communication voice, a second memory 25 that stores various information, and a second control unit 26 that controls the whole separating member 20.

When the phone body 10 and the separating member 20 are in the separation state, the radio communication between the phone body 10 and the separating member 20 is realized by the BT communication using communication voice and control signals between the first BT communication unit 14 and the second BT communication unit 23. The radio communication between the phone body 10 and the separating member 20 realizes a voice communication of the phone body 10 by using the first speaker 11 and the first microphone 12, and realizes the voice communication of the separating member 20 by using the second speaker 21 and the second microphone 22.

The radio communication with the radio communication network 2 in the combination state of the phone body 10 and the separating member 20 realizes the voice communication with the radio communication network 2 through the radio communication unit 13. The mobile phone 1 in the compact storage standby state realizes the voice communication with the radio communication network 2 by using the first speaker 11 and the first microphone 12.

The mobile phone 1 in the normal communication standby state realizes the voice communication with the radio communication network 2 by using the first speaker 11 and the second microphone 22.

Moreover, if separation of the separating member 20 is detected during the communication with the radio communication network 2, the phone body 10 establishes the voice communication with the separating member 20 with the BT communication, and establishes the tripartite communication among the radio communication network 2, the phone body 10, and the separating member 20.

Furthermore, during the tripartite communication among the phone body 10, the separating member 20, and the radio communication network 2, if the separating member 20 is combined with and connected to the phone body 10, the voice communication between the phone body 10 and the radio communication network 2 is realized. The voice communication with the radio communication network 2 is realized by using the first speaker 11 and the second microphone 22.

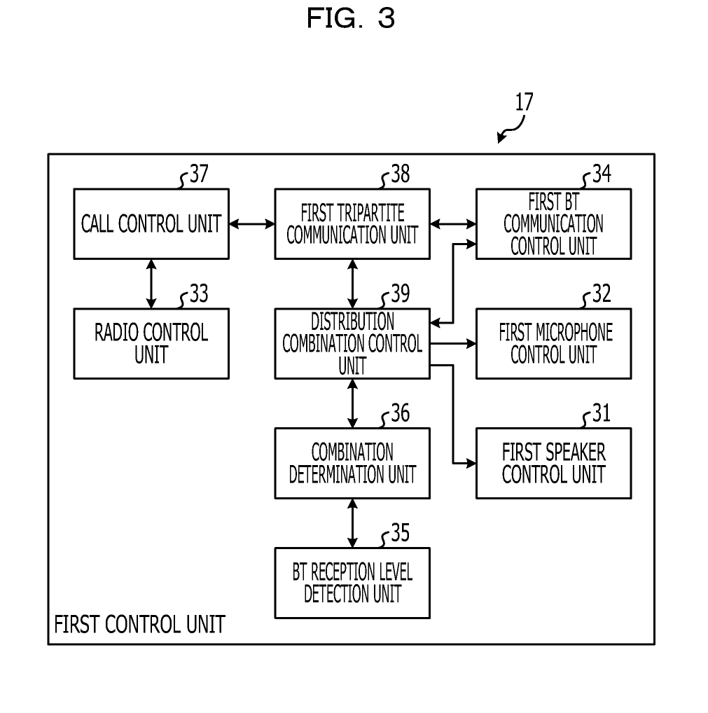

FIG. 3 is a block diagram illustrating an outline configuration inside the first control unit 17.

The first control unit 17 illustrated in FIG. 3 includes a first speaker control unit 31 that controls the first speaker 11, a first microphone control unit 32 that controls the first microphone 12, a radio control unit 33 that controls a radio communication unit 13, a first BT communication control unit 34 that controls the first BT communication unit 14, a BT reception level detection unit 35 that detects a reception level of the BT communication between the first BT communication unit 14 and the second BT communication unit 23, and a combination determination unit 36 that determines whether or not the phone body 10 and the separating member 20 are in the combination state based on the reception level detected by the BT reception level detection unit 35.

Furthermore, the first control unit 17 includes a call control unit 37 that manages the call control of the communication with the radio communication network 2, a first tripartite communication unit 38 that establishes a tripartite communication, and a distribution composition control unit 39 that controls the distribution composition unit 15.

Based on the reception level detected by the BT reception level detection unit 35, the combination determination unit 36 determines that the phone body 10 and the separating member 20 are in the combination state if the reception level of the BT communication between the first BT communication unit 14 on the phone body 10 side and the second BT communication unit 23 on the separating member 20 side is or higher than a standard threshold value, that is, a combination level.

Furthermore, the combination determination unit 36 determines that the phone body 10 and the separating member 20 are in the separation state if the reception level of the BT communication is lower than the standard threshold value, that is, the combination level.

The call control unit 37 controls a communication protocol with the radio communication network 2 through the radio communication unit 13.

If a tripartite communication request is detected during the voice communication between the phone body 10 and the radio communication network 2, the first tripartite communication unit 38 establishes a tripartite communication among the phone body 10, the separating member 20, and a partner of the radio communication network 2 through the first BT communication control unit 34 and the distribution composition control unit 39.

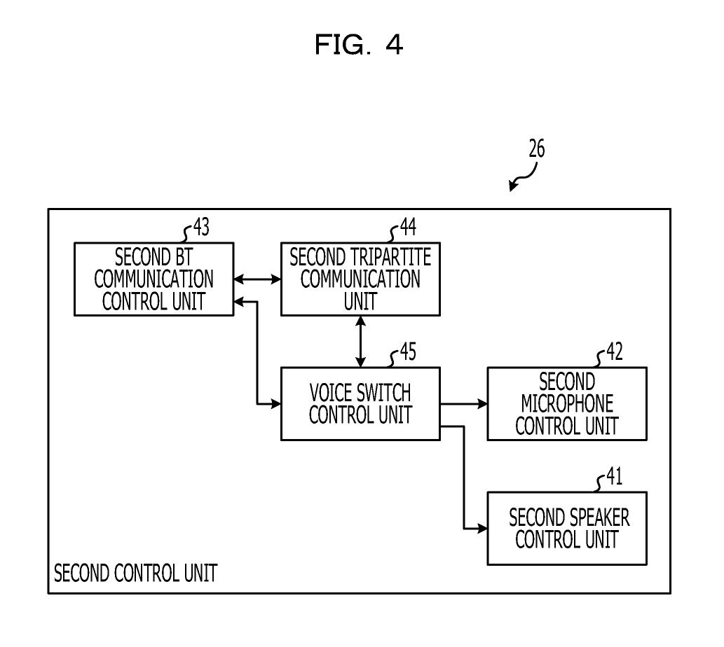

FIG. 4 is a block diagram illustrating an outline configuration inside the second control unit 26.

The second control unit 26 illustrated in FIG. 4 includes a second speaker control unit 41 that controls the second speaker 21, a second microphone control unit 42 that controls the second microphone 22, a second BT communication control unit 43 that controls the second BT communication unit 23, a second tripartite communication unit 44 that establishes a tripartite communication in conjunction with the first tripartite communication unit 38 on the phone body 10 side, and a voice switch control unit 45 that controls the voice switching unit 24.

The second tripartite communication unit 44 establishes, through the second BT communication unit 23, the tripartite communication among the phone body 10, the separating member 20, and the partner of the radio communication network 2.

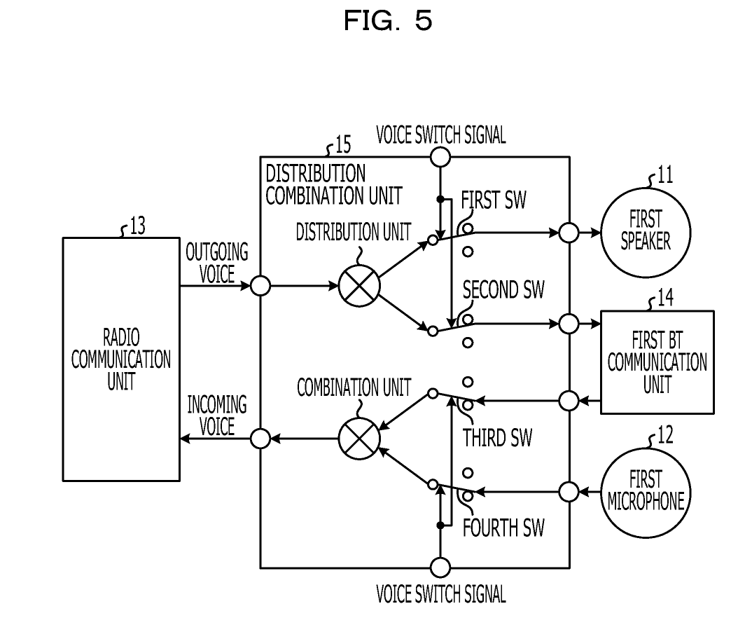

FIG. 5 is a block diagram illustrating an outline configuration inside the distribution composition unit 15.

The distribution composition unit 15 illustrated in FIG. 5 includes a distribution unit 51 that distributes an outgoing voice from the radio communication network 2 to the mobile phone 1 through the radio communication unit 13, that is, a received voice, to the phone body 10 and/or the separating member 20, a composition unit 52 that composes the outgoing voice from the phone body 10 and/or the separating member 20 to the radio communication network 2, that is, a transmitted voice, a first switch (hereinafter referred to as SW) 53A that turns on/off the connection between the distribution unit 51 and the first speaker 11, and a second SW 53B that turns on/off the connection between the distribution unit 51 and the first BT communication unit 14.

Furthermore, the distribution composition unit 15 includes a third SW 53C, which turns on/off the connection between the first BT communication unit 14 and the composition unit 52, and a fourth SW 53D, which turns on/off the connection between the first microphone 12 and the composition unit 52.

The distribution composition control unit 39 outputs a voice switch signal that performs ON/OFF control of the first SW 53A, the second SW 53B, the third SW 53C, and the fourth SW 53D.

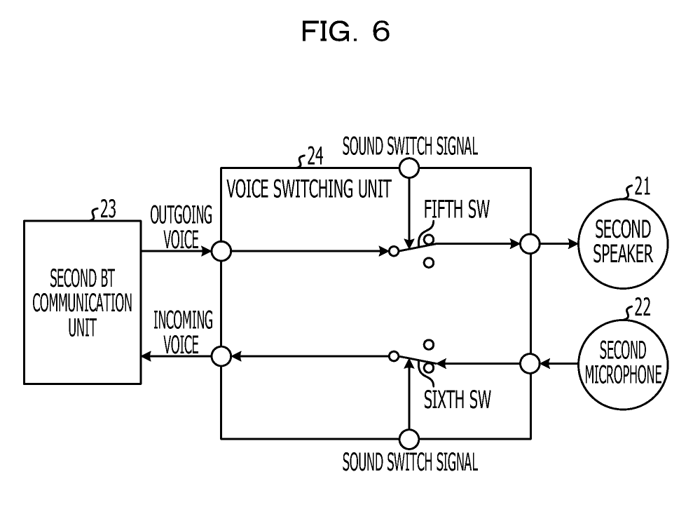

FIG. 6 is a block diagram illustrating an outline configuration inside the voice switching unit 24.

The voice switching unit 24 illustrated in FIG. 6 includes a fifth SW 61A that turns on/off the connection between the second BT communication unit 23 and the second speaker 21, and a sixth SW 61B that turns on/off the connection between the second BT communication unit 23 and the second microphone 22.

The voice switch control unit 45 outputs a voice switch signal that performs the on/off control of the fifth SW 61A and the sixth SW 61B.

During the tripartite communication among the phone body 10, the separating member 20, and the partner of the radio communication network 2, if the combination determination unit 36 detects the combination state of the phone body 10 and the separating member 20, the first control unit 17, through the distribution and composition control unit 39 and the voice switch control unit 45, turns on the first SW 53A between the distribution unit 51 and the first speaker 11, turns off the second SW 53B between the distribution unit 51 and the first BT communication unit 14, turns on the third SW 53C between the composition unit 52 and the first BT communication unit 14, turns off the fourth SW 53D between the composition unit 52 and the first microphone 12, turns off the fifth SW 61A between the second BT communication unit 23 and the second speaker 21, and turns on the sixth SW 61B between the second BT communication unit 23 and the second microphone 22.

As a result, by turning off the first microphone 12 and the second speaker 21 while the first speaker 11 and the second microphone 22 are turned off, the first control unit 17 realizes a communication between the phone body 10 and the partner of the first microphone 12 while suppressing howling between the first microphone 12 on the phone body 10 side and the second speaker 21 on the separating member 20 side even if the separating member 20 is combined during the tripartite communication.

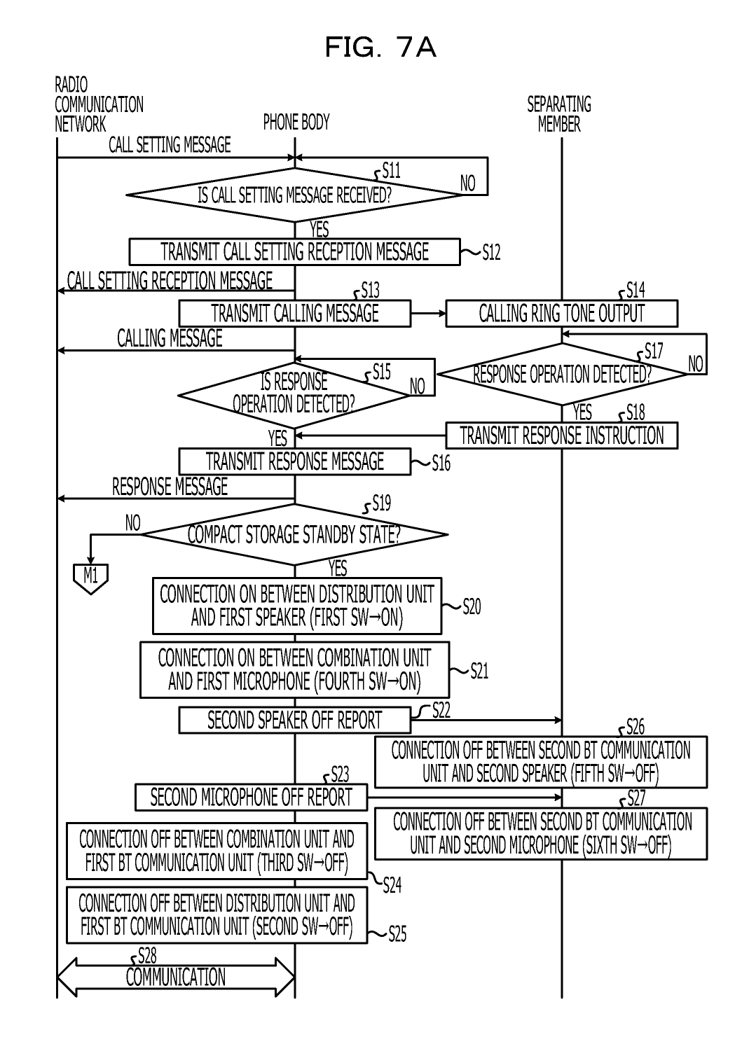

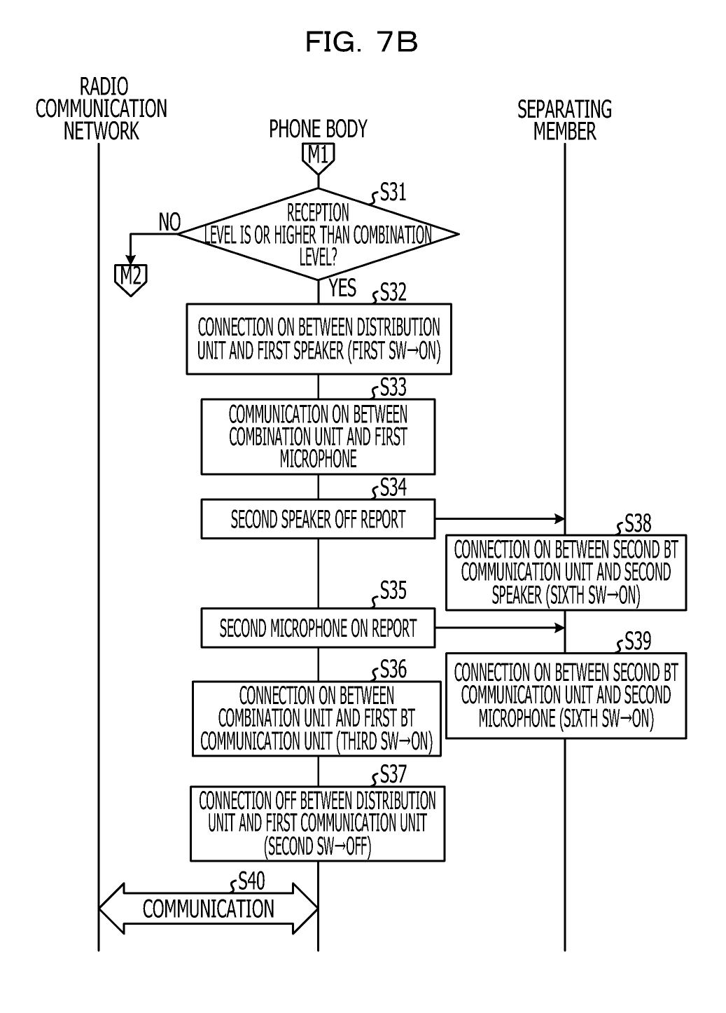

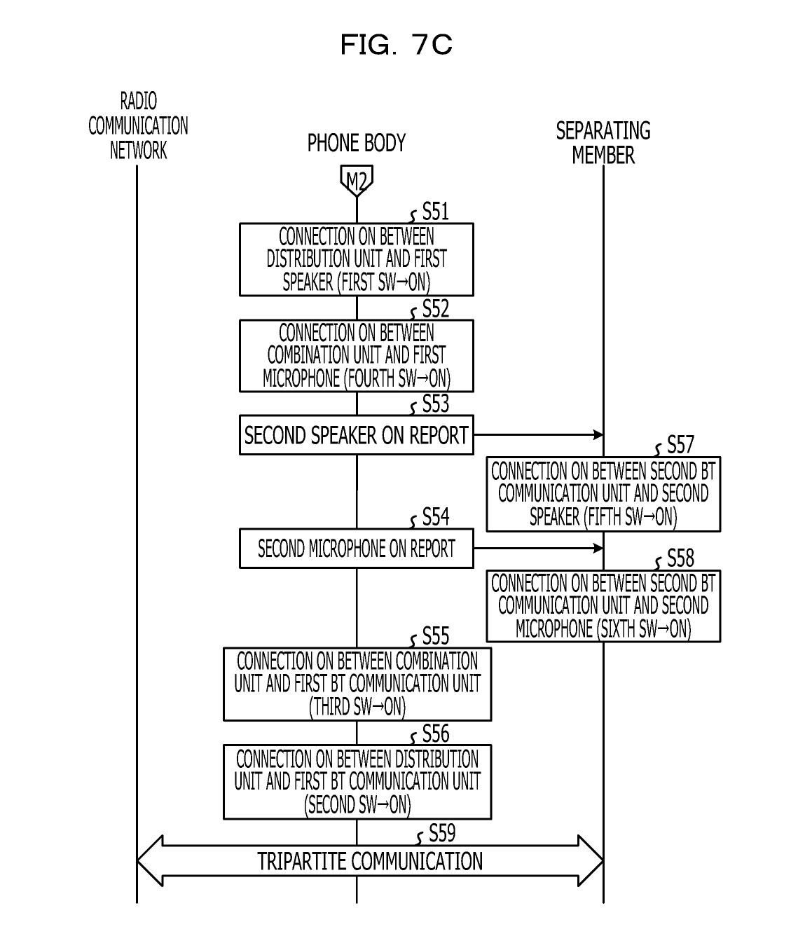

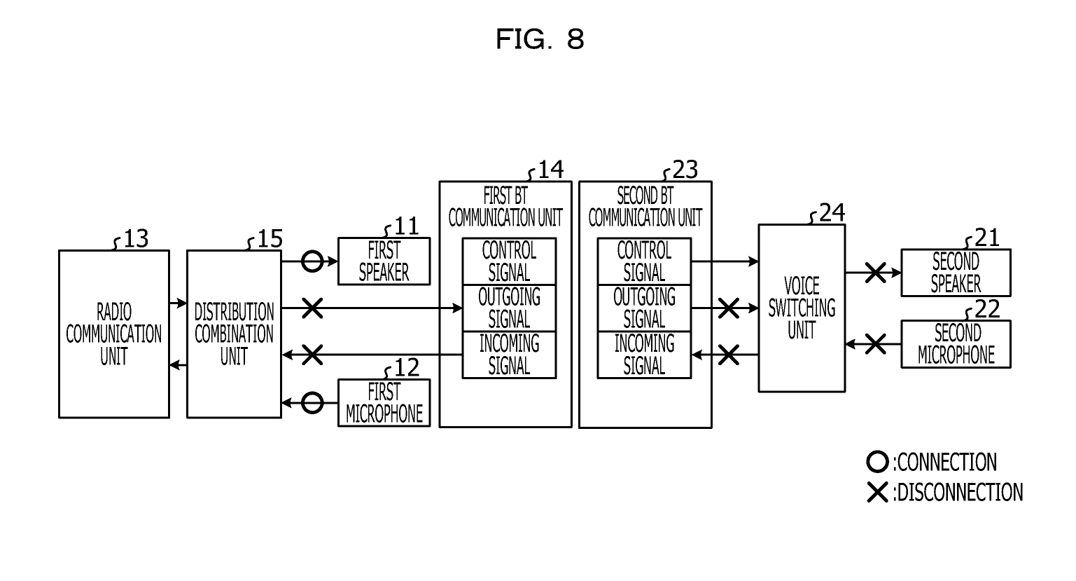

Next, description will be made of operations of the mobile phone 1 according to an embodiment. FIG. 7A is an operation sequence illustrating processing operations of the phone body 10, the separating member 20, and the radio communication network 2 related to communication voice switching processing. FIG. 8 is an explanation diagram clearly illustrating operations of the communication voice switching processing of the phone body 10 and the separating member 20 related to a time of an incoming call in the compact storage standby state.

The call control unit 37 in the phone body 10 illustrated in FIG. 7A determines whether or not a call setting message (SETUP) is received from the radio communication network 2 through the radio communication unit 13 (Operation S11).

If the call setting message is received (Yes at Operation S11), the call control unit 37 in the phone body 10 transmits a call setting reception message (CALLPROC) to the radio communication network 2 (Operation S12).

After transmitting the call setting reception message, the call control unit 37 in the phone body 10 transmits a calling message (ALERT) to the radio communication network 2 (Operation S13), and outputs a calling ring tone to the separating member 20 via the first BT communication unit 14 and the second BT communication unit 23 (Operation S14).

The call control unit 37 in the phone body 10 determines whether or not a response operation in response to an incoming call is detected (Operation S15). If the response operation in response to the incoming call is detected (YES at Operation S15), the call control unit 37 in the phone body 10 transmits a response message (CONN) to the radio communication network 2 (Operation S16). The separating member 20 determines whether or not the response operation in response to the incoming call is detected during ring tone output (Operation S17). If the response operation in response to the incoming call is detected (Yes at Operation S17), the separating member 20 transmits a response instruction to the phone body 10 to instruct to transmit the response message of Operation S16 via the first BT communication unit 14 and the second BT communication unit 23 (Operation S18).

The first control unit 17 in the phone body 10 determines whether or not the mobile phone 1 is in the compact storage standby state (Operation S19).

If the mobile phone 1 is in the compact storage standby state (YES at Operation S19), the distribution composition control unit 39 in the phone body 10 turns on the first SW 53A (Operation S20) to turn on the connection between the distribution unit 51 and the first speaker 11, and turns on the fourth SW 53D (Operation S21) to turn on the connection between the composition unit 52 and the first microphone 12.

Furthermore, the first control unit 17 in the phone body 10 transmits a second speaker OFF report to the second control unit 26 in the separating member 20 via the first BT communication unit 14 and the second BT communication unit 23 (Operation S22), and transmits a second microphone OFF report to the second control unit 26 via the first BT communication unit 14 and the second BT communication unit 23 (Operation S23).

Moreover, the distribution composition control unit 39 in the phone body 10 turns off the third SW 53C (Operation S24) to turn off the connection between the composition unit 52 and the first BT communication unit 14, and turns off the second SW 53B (Operation S25) to turn off the communication between the distribution unit 51 and the first BT communication unit 14.

If the second speaker OFF report of Operation S22 is detected, the voice switch control unit 45 in the separating member 20 turns off the fifth SW 61A (Operation S26) to turn off the communication between the second BT communication unit 23 and the second speaker 21, and turns off the sixth SW 61B (Operation S27) to turn off the connection between the second BT communication unit 23 and the second microphone 22.

As a result, as illustrated in FIG. 8, when the mobile phone 1 in the compact storage standby state responds to the incoming call from the radio communication network 2, the communication between the phone body 10 and the partner of the radio communication network 2 may be established by turning on the connection between the distribution composition unit 15 (the distribution unit 51 in FIG. 5) in the phone body 10 and the first speaker 11, turning on the connection between the distribution composition unit 15 (the composition unit 52 in FIG. 5) in the phone body 10 and the first microphone 12, turning off the distribution composition unit 15 (the composition unit 52 in FIG. 5) and the first BT communication unit 14, turning off the connection between the distribution composition unit 15 (the distribution unit 51 in FIG. 5) and the first BT communication unit 14, that is, turning on the first speaker 11 and the first microphone 12, turning off the connection between the second BT communication unit 23 and the second speaker 21, and turning off the connection between the second BT communication unit 23 and the second microphone 22, that is, turning off the second speaker 21 and the second microphone 22 (Operation S28).

If the call setting message is not received (NO at Operation S11), the process goes to Operation S11 so that the call control unit 37 in the phone body 10 monitors reception of the call setting message.

If the response operation is not detected (NO at Operation S15), the process goes to Operation S15 so that the call control unit 37 in the phone body 10 monitors the response operation.

If the response operation is not detected (NO at Operation S17), the process goes to Operation S17 so that the second control unit 26 in the separating member 20 monitors the response operation.

If the mobile phone 1 is not in the compact storage standby state (NO at Operation S19), the first control unit 17 in the phone body 10 is shifted to the terminal labeled as M1 illustrated in FIG. 7B.

In the communication voice switching processing illustrated in FIG. 7A, if the mobile phone 1 in the compact storage standby state responds to the incoming call from the radio communication network 2, the first speaker 11 and the first microphone 12 on the phone body 10 side are turned on, and the second speaker 21 and the second microphone 22 on the separating member 20 side are turned off. This makes it possible to establish a communication between the phone body 10 and the partner of the radio communication network 2.

FIG. 7B is an operation sequence of processing operations of the phone body 10, the separating member 20, and the radio communication network 2 related to the communication voice switching processing.

In the M1 illustrated in FIG. 7B, the combination determination unit 36 in the phone body 10 determines whether or not the reception level of the BT reception level detection unit 35 is or higher than the combination level (Operation S31).

If the reception level is or higher than the combination level (YES at Operation S31), the first control unit 17 in the phone body 10 determines that the mobile phone 1 is in the normal communication standby state because the phone body 10 and the separating member 20 are in the combination state.

If the mobile phone 1 is determined to be in the normal communication standby state, the distribution composition control unit 39 in the phone body 10 turns on the first SW 53A (Operation S32) to turn on the connection between the distribution unit 51 and the first speaker 11, and turns off the fourth SW 53D (Operation S33) to turn off the connection between the composition unit 52 and the first microphone 12.

Furthermore, the first control unit 17 in the phone body 10 transmits the second speaker OFF report to the second control unit 26 in the separating member 20 via the first BT communication unit 14 and the second BT communication unit 23 (Operation S34), and transmits the second microphone ON report to the second control unit 26 via the first BT communication unit 14 and the second BT communication unit 23 (Operation S35).

Moreover, the distribution composition control unit 39 in the phone body 10 turns on the third SW 53C (Operation S36) to turn on the connection between the composition unit 52 and the first BT communication unit 14, and turns off the second SW 53B (Operation S37) to turn off the connection between the distribution unit 51 and the first BT communication unit 14.

If the second speaker OFF report is detected of Operation S34, the voice switch control unit 45 in the separating member 20 turns off the fifth SW 61A (Operation S38) to turn off the connection between the second BT communication unit 23 and the second speaker 21, and turns on the sixth SW 61B (Operation S39) to turn on the connection between the second BT communication unit 23 and the second microphone 22.

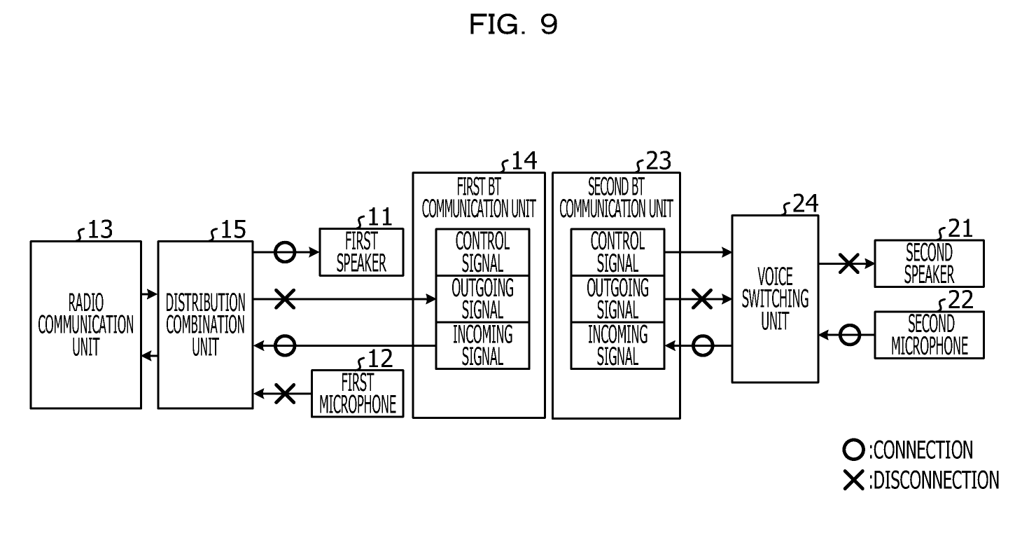

As a result, as illustrated in FIG. 9, when the mobile phone 1 in the normal communication standby state responds to the incoming call from the radio communication network 2, the communication between the phone body 10 and the partner of the radio communication network 2 is established by turning on the connection between the distribution composition unit 15 (the distribution unit 51 in FIG. 5) and the first speaker 11, turning off the connection between the distribution composition unit 15 (the composition unit 52 in FIG. 5) and the first microphone 12, turning on the connection between the distribution composition unit 15 (the composition unit 52 in FIG. 5) and the first BT communication unit 14, turning off the communication between the distribution composition unit 15 (the distribution unit 51 in FIG. 5) and the first BT communication unit 14, that is, turning on the first speaker 11 and turning off the first microphone 12, turning off the connection between the second BT communication unit 23 and the second speaker 21, and turning off the second microphone 22 (Operation S40).

If the reception level of the BT reception level detection unit 35 is not or not higher than the combination level (NO at Operation S31), the combination determination unit 36 in the phone body 10 determines that the phone body 10 and the separating member 20 are in the separation state, and is shifted to the terminal labeled as M2 illustrated in FIG. 7C.

In the communication voice switching processing illustrated in FIG. 7B, if the mobile phone 1 in the normal communication standby state responds to the incoming call from the radio communication network 2, the communication between the phone body 10 and the partner of the radio communication network 2 may be established by turning on the first speaker 11 on the phone body 10 side, turning off the first microphone 12, turning off the second speaker 21 on the separating member 20 side, and turning on the second microphone 22.

FIG. 7C is an operation sequence illustrating processing operations of the phone body 10, the separating member 20, and the radio communication network 2 related to the communication voice switching processing.

In the M2 illustrated in FIG. 7C, if the phone body 10 and the separating member 20 are determined to be in the separation state, the distribution composition control unit 39 in the phone body 10 turns on the first SW 53A (Operation S51) to turn on the connection between the distribution unit 51 and the first speaker 11, and turns on the fourth SW 53D (Operation S52) to turn on the connection between the composition unit 52 and the first microphone 12.

Furthermore, the first control unit 17 in the phone body 10 transmits the second speaker ON report to the second control unit 26 in the separating member 20 via the first BT communication unit 14 and the second BT communication unit 23 (Operation S53), and transmits the second microphone ON report to the second control unit 26 via the first BT communication unit 14 and the second BT communication unit 23 (Operation S54).

Moreover, the distribution composition control unit 39 in the phone body 10 turns on the third SW 53C (Operation S55) to turn on the connection between the composition unit 52 and the first BT communication unit 14, and turns on the second SW 53B (Operation S56) to turn on the connection between the distribution unit 51 and the first BT communication unit 14.

If the second speaker ON report of Operation S53 is detected, the voice switch control unit 45 in the separating member 20 turns on the fifth SW 61A (Operation S57) to turn on the connection between the second BT communication unit 23 and the second speaker 21. If the second microphone ON report of Operation S54 is detected, the voice switch control unit 45 in the separating member 20 turns on the sixth SW 61B (Operation S58) to turn on the connection between the second BT communication unit 23 and the second microphone 22.

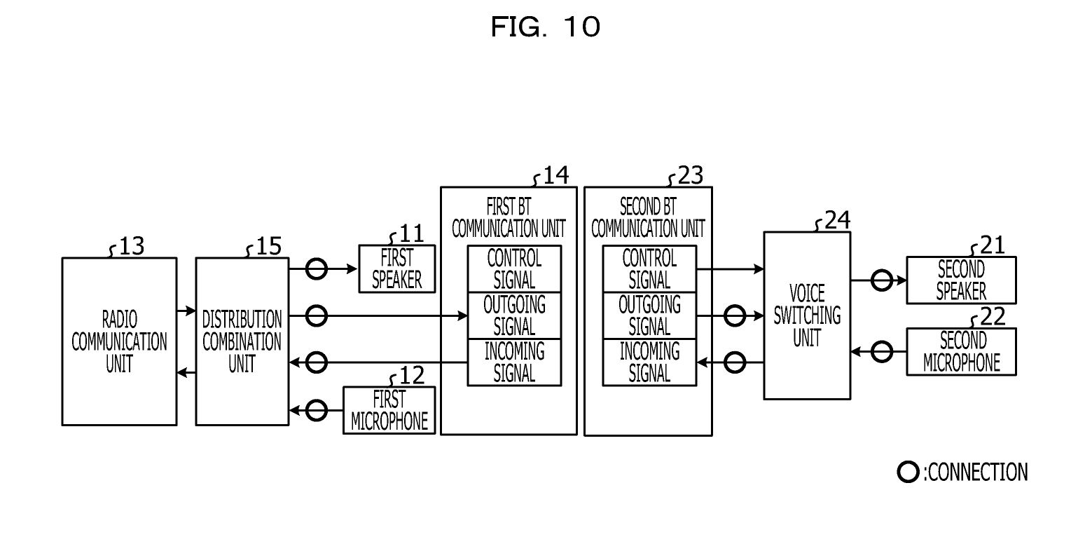

As a result, as illustrated in FIG. 10, in the separation state of the mobile phone 1, the tripartite communication among the phone body 10, the separating member 20, and the partner of the radio communication network 2 is established by turning on the connection between the distribution composition unit 15 in the phone body 10 (the distribution unit 51 in FIG. 5) and the first speaker 11, turning on the connection between the distribution composition unit 15 (the composition unit 52 in FIG. 5) and the first microphone 12, turning on the connection between the distribution composition unit 15 (the composition unit 52 in FIG. 5) and the first BT communication unit 14, turning on the connection between the distribution composition unit 15 (the distribution unit 51 in FIG. 5) and the first BT communication unit 14, that is, turning on the first speaker 11 and the first microphone 12, and turning on the connection between the second BT communication unit 23 and the second speaker 21, turning on the connection between the second BT communication unit 23 and the second microphone 22, that is, turning on the second speaker 21 and the second microphone 22 (Operation S59).

In the communication voice switching processing illustrated in FIG. 7C, when the mobile phone 1 in the separation state responds to the incoming call from the radio communication network 2, the first speaker 11 and the first microphone 12 on the phone body 10 side are turned on and the second speaker 21 and the second microphone 22 on the separating member 20 side are turned on. This makes it possible to establish the tripartite communication among the phone body 10, the separating member 20, and the partner of the radio communication network 2.

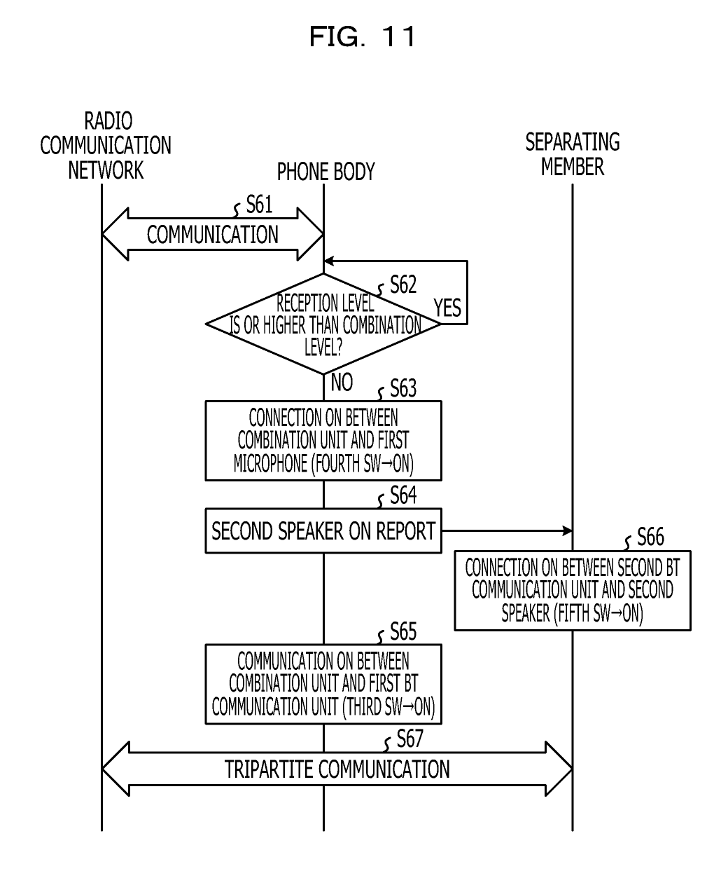

Next, description will be made of an operation of a case where the separating member 20 is separated during the communication between the mobile phone 1 and the partner of the radio communication network 2. FIG. 11 is an operation sequence illustrating processing operations of the phone body 10, the separating member 20, and the radio communication network 2 when the normal communication is shifted to the tripartite communication.

In FIG. 11, during the communication with the partner of the radio communication network 2 (Operation S61), the combination determination unit 36 in the phone body 10 determines whether or not the reception level of the BT reception level detection unit 35 is or higher than the combination level (Operation S62).

As illustrated in FIG. 9, during the communication between the mobile phone 1 and the partner of the radio communication network 2 in the normal communication standby state, the connection between the distribution unit 51 and the first speaker 11 is turned on, the connection between the composition unit 52 and the first microphone 12 is turned off, the connection between the distribution unit 51 and the first BT communication unit 14 is turned off, the connection between the composition unit 52 and the first BT communication unit 14 is turned on, that is, the first speaker 11 and the second microphone 22 are turned on, and the first microphone 12 and the second speaker 21 are turned off.

If the reception level is not or not higher than the combination level (NO at Operation S62), the distribution composition control unit 39 in the phone body 10 determines that the phone body 10 and the separating member 20 are in the separation state, and turns on the fourth SW 53D (Operation S63) to turn on the connection between the composition unit 52 and the first microphone 12.

Furthermore, the first control unit 17 in the phone body 10 transmits the second speaker ON report to the second control unit 26 in the separating member 20 via the first BT communication unit 14 and the second BT communication unit 23 (Operation S64).

Moreover, the distribution composition control unit 39 in the phone body 10 turns on the third SW 53C (Operation S65) to turn on the connection between the composition unit 52 and the first BT communication unit 14.

If the second speaker ON report of Operation S64 is detected, the voice switch control unit 45 in the separating member 20 turns on the fifth SW 61A (Operation S66) to turn on the connection between the second BT communication unit 23 and the second speaker 21.

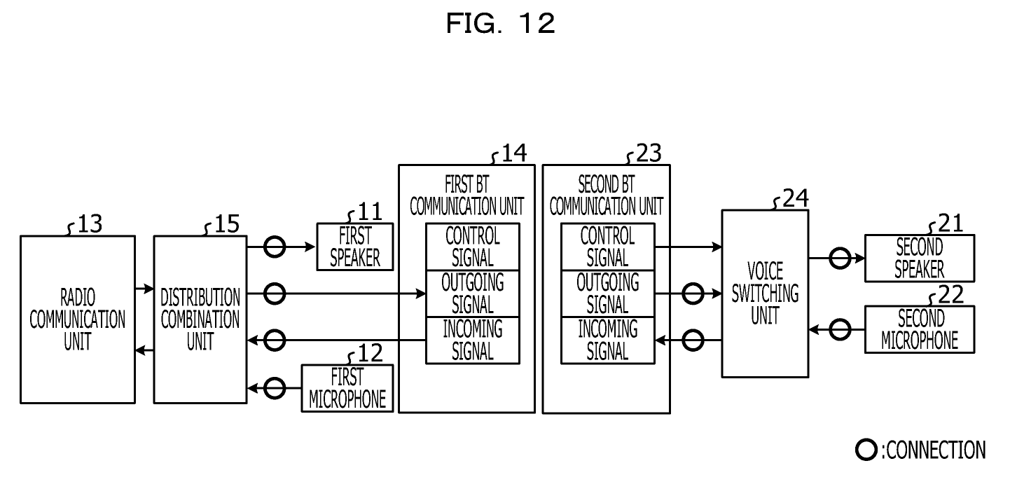

As a result, as illustrated in FIG. 12, the tripartite communication among the phone body 10, the separating member 20, and the partner of the radio communication network 2 is established by turning on the connection between the distribution composition unit 15 and the first speaker 11 in the phone body 10 (the distribution unit 51 in FIG. 5), turning on the connection between the distribution composition unit 15 (the composition unit in FIG. 5) and the first microphone 12, turning on the connection between the distribution composition unit 15 (the composition unit in FIG. 5) and the first BT communication unit 14, turning on the connection between the distribution composition unit 15 (the distribution unit 51 in FIG. 5) and the first BT communication unit 14, that is, turning on the first speaker 11 and the first microphone 12, and turning on the connection between the second BT communication unit 23 and the second speaker 21, turning on the connection between the second BT communication unit 23 and the second microphone 22, that is, turning on the second speaker 21 and the second microphone 22 (Operation S67).

If the reception level of the BT reception level detection unit 35 is or higher than the combination level (YES at Operation S62), the combination determination unit 36 in the phone body 10 determines that the phone body 10 and the separating member 20 are in the combination state, and then the process goes to Operation S62 so that the combination determination unit 36 monitors whether or not the reception level is or higher than the combination level.

In the processing illustrated in FIG. 11, if the separating member 20 is separated from the phone body 10 during the communication between the phone body 10 and the partner of the radio communication network 2, the tripartite communication among the phone body 10, the separating member 20, and the partner of the radio communication network 2 may be established by turning on the first speaker 11 and the first microphone 12 on the phone body 10 side and turning on the second speaker 21 and the second microphone 22 on the separating member 20 side.

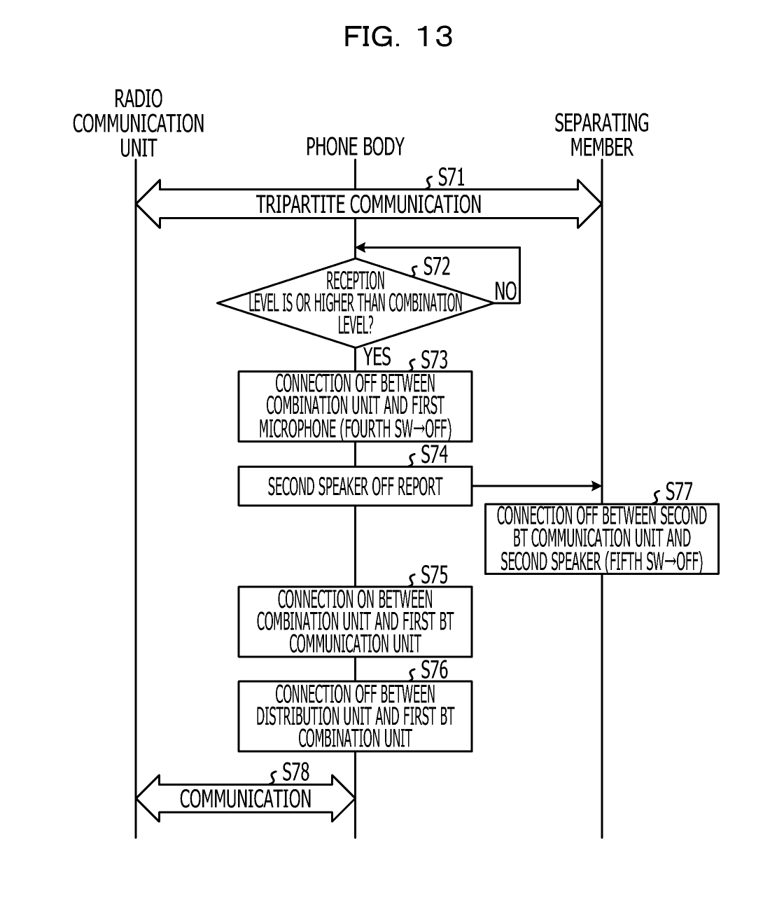

Next, description will be made of an operation in a case where the separating member 20 is combined with the phone body 10 during the tripartite communication among the phone body 10, the separating member 20, and the partner of the radio communication network 2. FIG. 13 is an operation sequence illustrating processing operations of the phone body 10, the separating member 20, and the radio communication network 2 when the tripartite communication is shifted to the normal communication.

In FIG. 13, during the tripartite communication between the separating member 20 and the partner of the radio communication network 2 (Operation S71), the combination determination unit 36 in the phone body 10 determines whether or not the reception level of the BT reception level detection unit 35 is or higher than the combination level (Operation S72).

As illustrated in FIG. 12, during the tripartite communication among the phone body 10, the separating member 20, and the partner of the radio communication network 2, the connection between the distribution unit 51 and the first speaker 11 is turned on, the connection between the composition unit 52 and the first microphone 12 is turned on, the connection between the distribution unit 51 and the first BT communication unit 14 is turned on, the connection between the composition unit 52 and the first BT communication unit 14 is turned on, the connection between the second speaker 21 and the second BT communication unit 23 is turned on, the connection between the second microphone 22 and the second BT communication unit 23, that is, the first speaker 11, the first microphone 12, the second speaker 21, and the second microphone 22 are turned on.

If the reception level is or higher than the combination level (YES at Operation S72), the distribution composition control unit 39 in the phone body 10 determines that the phone body 10 and the separating member 20 are in the combination state, and turns off the fourth SW 53D (Operation S73) to turn off the connection between the composition unit 52 and the first microphone 12.

Furthermore, the first control unit 17 in the phone body 10 transmits the second speaker OFF report to the second control unit 26 in the separating member 20 via the first BT communication unit 14 and the second BT communication unit 23 (Operation S74).

Moreover, the distribution composition control unit 39 in the phone body 10 turns on the third SW 53C (Operation S75) to turn on the connection between the composition unit 52 and the first BT communication unit 14, and turns off the second SW 53B (Operation S76) to turn off the connection between the distribution unit 51 and the first BT communication unit 14.

If the second speaker OFF report of Operation S74 is detected, the voice switch control unit 45 in the separating member 20 turns off the fifth SW 61A (Operation S77) to turn off the connection between the second BT communication unit 23 and the second speaker 21.

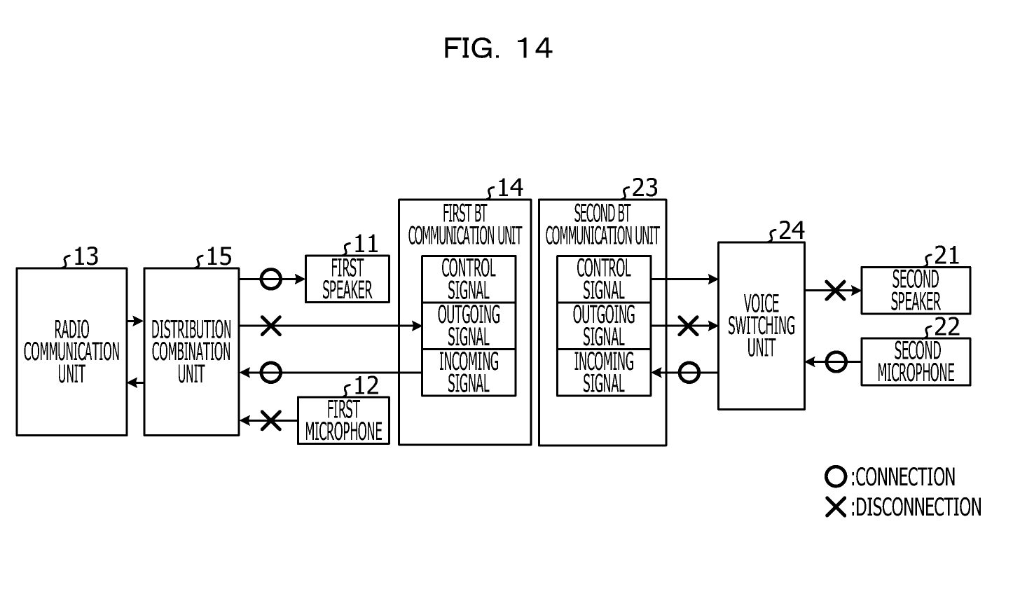

As a result, as illustrated in FIG. 14, the mobile phone 1 shifts the communication to the communication between the phone body 10 and the radio communication network 2 by turning on the communication between the distribution composition unit 15 in the phone body 10 and the first speaker 11, turning off the communication between the distribution composition unit 15 (the composition unit 52 in FIG. 5) and the first microphone 12, turning on the connection between the distribution composition unit 15 (the composition unit 52 in FIG. 5) and the first BT communication unit 14, turning on the communication between the distribution composition unit 15 (the distribution unit 51 in FIG. 5) and the first BT communication unit 14, that is, turning on the first speaker 11 and turning off the first microphone 12, turning off the connection between the second BT communication unit 23 and the second speaker 21, turning on the connection between the second BT communication unit 23 and the second microphone 22, turning off the second speaker 21, and turning on the second microphone 22 (Operation S78).

If the reception level of the BT reception level detection unit 35 is not or not higher than the combination level (NO at Operation 72), that is, the phone body 10 and the separating member 20 are determined to be in the separation state, the process goes to Operation S72 so that the combination determination unit 36 in the phone body 10 monitors whether or not the reception level is or higher than the combination level.

In the processing illustrated in FIG. 13, if the separating member 20 is combined with and connected to the phone body 10 during the tripartite communication among the phone body 10, the separating member 20, and the partner of the radio communication network 2, the first speaker 11 on the phone body 10 side and the second microphone 22 on the separating member 20 side are turned off while the first speaker 11 on the phone body 10 side and the second microphone 22 on the separating member 20 side are turned on. This makes it possible to establish a communication between the phone body 10 and the partner of the radio communication network 2 while the howling between the first microphone 12 and the second speaker 21 is being suppressed.

According to an embodiment, if the separating member 20 is combined with and connected to the phone body 10 during the tripartite communication among the phone body 10, the separating member 20, and the partner of the radio communication network 2, the first microphone 12 on the phone body 10 side and the second speaker 21 on the separating member 20 side are turned off while the first speaker on the phone body 10 side and the second microphone 22 on the separating member 20 side are turned on. This makes it possible to establish a communication between the phone body 10 and the radio communication network 2 while the howling between the first microphone 12 and the second speaker 21 is being suppressed.

According to the above-described embodiments, the first speaker 11, the first microphone 12, the second speaker 21, and the second microphone 22 are turned on/off by turning on/off the first SW 53A, the second SW 53B, the third SW 53C, the fourth SW 53D, the fifth SW 61A, and the sixth SW 61B. It is obvious that the same efficiency may be obtained even if an output level of the first speaker 11 and the second speaker is adjusted and a voice collecting level of the first microphone 12 and the second microphone 22 is adjusted while the SW is turned on.

If the separating member 20 is combined with and connected to the phone body 10 during the tripartite communication among the phone body 10, the separating member 20, and the partner of the radio communication network 2, it is obvious that the same efficiency may be obtained even if the howling between the first microphone 12 and the second speaker 21 is suppressed by reducing the voice collecting level of the first microphone 12 and the output level of the second speaker 21 while the first microphone 12 on the phone body 10 side and the second speaker 21 on the separating member 20 side are turned on.

According to the above-described embodiment, the combination determination unit 36 determines whether or not the phone body 10 is combined with and connected to the separating member 20 based on the reception level of the BT communication. The combination determination unit 36 may determine whether or not the phone body 10 is close to the separating member 20 to an extent that howling is caused between the first microphone 12 on the phone body 10 side and the second speaker 21 on the separating member 20 side. This may be realized by changing setting of a standard threshold value of the combination determination unit 36.

According to the above-described embodiment, the connection between the phone body 10 and the separating member 20 is realized by the BT communication. The same efficiency may be obtained by a method of a direct radio communication between the phone body 10 and the separating member 20 even if other methods such as an infrared communication or the like are employed.

According to the above-described embodiment, if the separating member 20 is combined with and connected to the phone body 10 during the tripartite communication, both the first microphone 12 and the second speaker 21 are turned off. Since the howling between the first microphone 12 and the speaker 21 may be suppressed, the same efficiency may be obtained even if at least either the first microphone 12 or the second speaker 21 is turned off.

The various processing described in the above-described embodiments may be realized by executing programs, which are previously prepared, in the mobile phone 1. In this case, each program is stored in a storage medium such as a ROM (not illustrated) in the mobile phone 1. The CPU (not illustrated) in the mobile phone 1 reads out and executes these programs. Therefore, each of the processing units may be realized.

Each of the above-described programs may not always be stored in the ROM. For example, the program may be stored in a portable physical medium to be inserted into the mobile phone 1 or in a fixed physical medium to be provided in the mobile phone 1. The mobile phone 1 may read out each of the programs from the above-described storage medium and execute the program.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention, the scope of which is defined in the claims and their equivalents.

What is claimed is:

1. A communication terminal device, comprising:
a terminal body which enables a communication with a radio communication network by a first radio communication,
a separating member which may be separated from the terminal body and enables a communication with the terminal body by a second radio communication,
a tripartite communication unit which enables a tripartite communication among the terminal body, the separating member, and the radio communication network when the separating member and the terminal body are separated, and
a control unit which controls howling between the terminal body and the separating member when the separating member and the terminal body are close during the tripartite communication.

2. The communication terminal device according to claim 1, wherein the control unit controls the howling between a first transmission unit and a first reception unit on a side of the terminal body and a second transmission unit and a second reception unit on a side of the separating member.

3. The communication terminal device according to claim 2, wherein an upper part of the separating member and a lower part of the terminal body are detachably combined with and connected with each other,
wherein the first reception unit is allocated on the upper part of the terminal body and the first transmission unit is allocated on the lower part of the terminal body,
and wherein the control unit controls the howling caused between the terminal body and the separating member by setting a status of the first reception unit and the second transmission unit to turn on and a status of the first transmission unit and the second reception unit to turn off when the separating member and the terminal body are close to each other during the tripartite communication.

4. The communication terminal device according to claim 2, wherein the upper part of the separating member and a lower part of the terminal body are detachably combined and connected with each other,
wherein the first reception unit is allocated on the upper part of the terminal body and the first transmission unit is allocated on the lower part of the terminal body,
wherein the second reception unit is allocated on the upper part of the separating member and the second transmission unit is allocated on the lower part of the separating member,
and wherein the control unit controls the howling caused between the terminal body and the separating member by setting a status of the first reception unit and the second transmission unit to turn on and adjusting a voice collecting sensitivity of the first transmission unit and an output voice volume of the second reception unit.

5. The communication terminal device according to claim 3, wherein the terminal body comprising:
a distribution composition unit which composes a communication voice into a transmission voice to the radio communication network from the second transmission unit and distributes a reception voice from the radio communication network to the first reception unit and the second reception unit.

6. The communication terminal device according to claim 1, wherein the terminal body comprises a first radio communication unit which establishes the first radio communication and a second radio communication unit which establishes the second radio communication with the separating member,
wherein the separating member comprises a third radio communication unit which establishes the second radio communication with the terminal body, and
wherein the tripartite communication unit establishes a tripartite communication among the terminal body, the separating member, and the radio communication network by establishing the first radio communication by using the first radio communication unit and by establishing the second radio communication by using the second radio communication unit and the third radio communication unit.

7. The communication terminal device according to claim 1, wherein the first radio communication unit includes a terminal state determination unit which determines that the terminal body and the separating member are close to each other when a reception level of the second radio communication reaches a first threshold level, and that the terminal body and the separating member are separated from each other when the reception level of the second radio communication is lower than a second threshold level.

8. The communication terminal device according to claim 1, the second radio communication is a radio communication using a Bluetooth technology.

9. The communication terminal device according to claim 1, wherein a case where the separating member and the terminal body are close to each other includes a case where the separating member and the terminal body are combined with and connected with each other.

10. A tripartite communication method which is executed by a communication terminal device having a terminal body, which enables a communication with a radio communication network by a first radio communication, and a separating member, which may be separated from the terminal body and enables a communication with the terminal body by a second radio communication, the method comprising:
enabling a tripartite communication among the terminal body, the separating member, and the radio communication network when the separating member and the terminal body are separated; and
controlling howling between the terminal body and the separating member when the separating member and the terminal body are close during the tripartite communication.

11. A computer readable storage medium storing a tripartite communication program to be executed, by a communication terminal device having a terminal body, which enables a communication with a radio communication network by a first radio communication, and a separating member, which may be separated from the terminal body and enables a communication with the terminal body by a second radio communication, execution of the program causing the communication terminal device to perform a process comprising:
enabling a tripartite communication among the terminal body, the separating member, and the radio communication network when the separating member and the terminal body are separated; and
controlling howling between the terminal body and the separating member when the separating member and the terminal body are close during the tripartite communication.
